(19) United States
(12) Patent Application Publication
(10) Pub. No.: US 2011/0018892 A1
(43) Pub. Date: Jan. 27, 2011

(54) METHOD, DEVICE, AND PROGRAM FOR PROCESSING IMAGE AND IMAGE DISPLAY DEVICE

(75) Inventors: Masayuki OTAWARA, Yokohama (JP); Hidehito OGAWA, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/729,403

(22) Filed: Mar. 23, 2010

(30) Foreign Application Priority Data
Jul. 24, 2009 (JP) 2009-172770
Oct. 5, 2009 (KR) 10-2009-0094279

(51) Int. Cl. G09G 5/02

(52) U.S. Cl. 345/589; 345/690

(57) ABSTRACT

Provided are image signal processing devices, image signal processing methods, programs and display devices for improving the quality of an image. The image signal processing device includes a first color space converting unit for outputting hue signals, saturation signals, and first luminance signals with respect to each of a plurality of pixels based on the input image signals; a margin value calculating unit for calculating margin values for the hues based on the corresponding hue signals; a control value set up unit for setting up control values controlling the corresponding first luminance signals based on the corresponding saturation signals and the corresponding margin values; a brightness adjusting unit for adjusting brightnesses of the first luminance signals based on the corresponding control values and outputting second luminance signals with adjusted brightnesses.

### CROSS-REFERENCE TO RELATED PATENT APPLICATIONS

This application claims the benefits of Japanese Patent Application No. 2009-172770, filed on Jul. 24, 2009 in the Japanese Patent Office, and Korean Patent Application No. 10-2009-0094279, filed on Oct. 5, 2009 in the Korean Intellectual Property Office, the disclosures of which are incorporated herein in their entirety by reference.

### BACKGROUND

1. Field

Exemplary embodiments of the present inventive concept relate to a method, a device, and a program for processing an image, and an image display device.

2. Description of the Related Art

Recently, various display devices, including an organic electroluminescence (EL) display (a.k.a. an organic light emitting diode (OLED) display), a field emission display (FED), a liquid crystal display (LCD), and a plasma display panel (PDP), have been developed to replace cathode ray tube (CRT) displays. Each of the above-stated display devices, including the CRT displays, has a predetermined dynamic range and is capable of displaying images of image signals that are input within a limited dynamic range.

For improved impressions of contrast within such a limited dynamic range, a technique of correcting image signals by composing image signal correction curves based on the image signals and correcting the image signals based on the image signal correction curves has been developed. For example, Japanese Patent Laid-Open Publication No. 2004-302311 (referred hereinafter as Cited Reference 1) discloses a method of improving the impressions of contrast by detecting a histogram of luminance signals based on image signals and correcting the image signals based on the detected histogram.

Furthermore, a technique of adjusting brightness by converting the color space of input image signals and adjusting the brightness based on the image signals having the converted color space has been developed. For example, Japanese Patent Laid-Open Publication No. 2005-184602 (referred hereinafter as Cited Reference 2) discloses a method of converting input image signals into image signals expressed within a color reproduction domain of an output device for outputting image signals by converting the color space of the input image signals and adjusting the hues and brightness of the image signal with the converted color space.

[1] Problems in Conventional Image Signal Processing Device for Correcting Image Signals Based on Histogram of Luminance Signals Based on the Image Signals

An image signal processing device, to which a related art (referred hereinafter as a “related art 1”) is applied, for correcting image signals based on a histogram of luminance signals based on the image signals corrects the image signals such that the contrast of luminance gradation at which the histogram shows the maximum number is improved.

FIGS. 8 through 10 are diagrams for describing a related art for correcting image signals based on a histogram of luminance signals based on the image signals. When an image shown in FIG. 8 is input, an image signal processing device to which the related art 1 is applied composes a histogram of luminance signals based on image signals of the image, as shown in FIG. 9. Then, the image signal processing device to which the related art 1 is applied corrects the image signals based on the histogram, such that the contrast of luminance gradation “128,” which is the maximum number, is improved, as shown in FIG. 10.

According to the related art 1, image signals are corrected such that the contrast of luminance gradation at which the histogram shows the maximum number is improved, as described above. Since the impression of contrast may be improved according to the related art 1, a conventional image signal processing device to which the related art 1 is applied may improve the quality of an image. However, the conventional image signal processing device to which the related art 1 is applied may not improve the quality of images with respect to any image signals. Hereinafter, the problems of the conventional image signal processing device to which the related art 1 is applied will be described in detail with reference to FIGS. 11A through 12E.

FIGS. 11A through 11E are diagrams for describing problems of an image signal processing device to which the related art 1 for correcting image signals based on a histogram of luminance signals based on the image signals is applied. In FIGS. 11A through 11E, an image signal expressed as 8-bit data (that is, an image signal capable of expressing 256 gradations) is shown as an example. Here, FIG. 11A shows an example of images problematic to a conventional image signal processing device. Furthermore, FIG. 11B shows an R signal corresponding to a red component (referred hereinafter as ‘R’) at each of the locations along a line a-b shown FIG. 11A. Similarly, FIG. 11C shows a G signal corresponding to a green component (referred hereinafter as ‘G’), FIG. 11D shows a B signal corresponding to a blue component (referred hereinafter as ‘B’), and FIG. 11E shows a luminance signal (i.e., a Y signal). As shown in each of FIGS. 11B through 11E, the left half of the image shown in FIG. 11A contains red components with different contrasts, and the right half of the image shown FIG. 11A contains yellow components with different contrasts. Furthermore, the Y signal is calculated according to Mathematical Expression 1 below based on signal levels of the R signal, the G signal, and the B signal, which constitute an image signal. FIG. 11E shows a case in which the lowest level of the Y signal is “28.”

Y=0.3R+0.59G+0.11B [Mathematical Expression 1]

In the case of the image shown in FIG. 11A, a clearer image may be obtained by improving the contrast of a portion P indicating yellow color in the image. Here, such an adjustment of contrast of a color is known, for example, as an adjustment of saturation of a color (or adjustment of a color). However, since the signal level of a portion Q indicating red color in the image is already at the maximum level, the portion Q becomes supersaturated if saturation is further increased, and thus the quality of the image is deteriorated.

FIGS. 12A through 12E are diagrams for describing a case in which the image shown in FIG. 11A is supersaturated by adjusting the saturation of colors, where the saturation of the image is doubled. Here, FIG. 12A shows an example of supersaturated images obtained by adjusting the saturation of colors in the image shown in FIG. 11A, and FIGS. 12B through 12E respectively show an R signal, a G signal, a B signal, and a Y signal at each of the locations on a line a-b shown in FIG. 12A.

As shown in FIGS. 12B and 12C, as saturation is doubled from the state shown in FIGS. 11A through 11E, the signal levels of R signals and G signals in the right half of the image indicating yellow color are doubled, and thus the contrast in the right half of the image is improved. However, as shown in FIG. 12B, the left half of the image indicating red color is supersaturated, and thus red gradation levels are deteriorated. In other words, the quality of the image shown in FIG. 12A is deteriorated as compared to the image shown in FIG. 11A.

As shown in FIGS. 11A through 12E, the quality of an image may be deteriorated by simply adjusting saturation. Here, according to the related art 1, image signals are corrected such that the contrast of luminance gradation, at the maximum number of the histogram, is improved as shown in FIGS. 8 through 10, and thus the quality of an image may be deteriorated as shown in FIGS. 12A through 12E even according to the related art 1. Therefore, improvement in the quality of an image cannot be expected according to the related art 1.

[2] Problems in Conventional Image Signal Processing Device for Converting Color Space of Input Image Signals and Adjusting Brightness Based on the Image Signals with Converted Color Space

An image signal processing device, to which a related art (referred hereinafter as a “related art 2”) is applied, for converting the color space of input image signals and adjusting brightness based on the image signals with the converted color space adjusts brightness by processing an input image signal such that the color space of the image signals is converted. However, a conventional image signal processing device to which the related art 2 is applied converts image signals into image signals expressed within the color reproduction domain of an output device for outputting image signals, and an operation for revolving colors is necessary. Furthermore, an image signal processing apparatus to which the related art 2 is applied adjusts brightness with respect to image signals with revolved colors. For example, even in the case where image signals indicating the image shown in FIG. 11A are input, images indicated by image signals output by a conventional image signal processing apparatus to which the related art 2 is applied may not always be the same image. In other words, in the case where image signals indicating the image shown in FIG. 11A are input, an image indicated by image signals output by a conventional image signal processing apparatus to which the related art 2 is applied may not even be at all similar to the image shown in FIG. 11A. Therefore, the improvement in the quality of the image cannot be expected according to the related art 2 for converting the color space of input image signals and adjusting brightness based on the image signals with the converted color space.

As described above, the improvement in the quality of an image via contrast improvement cannot be expected according to the related art 1 and/or the related art 2.

### SUMMARY

Aspects of the exemplary embodiments provide new and improved image signal processing devices, image signal processing methods, and programs and display devices for improving the quality of an image by improving contrast by selectively adjusting the brightness of an image based on input image signals.

According to an aspect of an exemplary embodiment, there is provided an image signal processing device including a first color space converting unit for converting a color space based on input image signals and outputting hue signals, saturation signals, and first luminance signals based on the input image signals; a margin value calculating unit for calculating margin values, which indicates margins with respect to maximum brightnesses, for the hue signals; a control value set up unit for setting up control values for controlling the corresponding first luminance signals based on the corresponding saturation signals and the corresponding margin values; a brightness adjusting unit for adjusting brightnesses of the first luminance signals based on the first luminance signals and the corresponding control values and outputting second luminance signals with adjusted brightnesses; and a second color space converting unit for converting a color space based on the hue signals, the saturation signals, and the second luminance signals and outputting image signals.

The image signal processing device may improve the quality of an image by improving contrast through selective adjustment of the brightnesses based on the input image signals.

The brightness adjusting unit may multiply the control values by the corresponding first luminance signals and output second luminance signals.

Accordingly, the image signal processing device may adjust the brightnesses of image signals for each of the pixels.

Furthermore, the control value set up unit may set up the control values based on corresponding maximum defining information including corresponding maximum values for defining the maximums of control values for the corresponding hue signals, and the control value set up unit may compare the margin values and the maximum values and may set up the control values by selectively using the corresponding margin values in the case where the corresponding maximum values are greater than the corresponding margin values and sets up the control values by selectively using the corresponding maximum values in the case where the corresponding maximum values is less than the corresponding margin values.

Accordingly, the image signal processing device may adjust the brightness of image signals for each of the pixels based on control values within the range of margin with respect to the maximum value of brightness or according to the maximum defined by maximum defining information.

According to an aspect of another exemplary embodiment, there is provided a method of processing an image, the method including converting a color space based on input image signals and outputting hue signals, saturation signals, and first luminance signals based on the input image signals; calculating margin values, which indicates the margins with respect to the maximum brightnesses, for the corresponding hue signals; setting up control values for controlling the corresponding first luminance signals based on the corresponding saturation signals and the corresponding margin values; adjusting brightnesses of the first luminance signals based on the first luminance signals and the corresponding control values and outputting second luminance signals with adjusted brightnesses; and converting a color space based on the hue signals, the saturation signals, and the second luminance signals and outputting output image signals.

According to the method, the quality of an image may be improved by improving contrast through selective adjustment of brightness based on input image signals.

According to an aspect of another exemplary embodiment, there is provided a computer program for executing steps of converting a color space based on input image signals, each of which includes an R signal corresponding to red hue, a G signal corresponding to green hue, and a B signal corresponding to blue hue, and outputting hue signals, saturation signals, and first luminance signals based on the input image signals; calculating margin values, which indicates margins with respect to maximum brightnesses, for the corresponding hue signals; setting up control values for controlling the first luminance signals based on the corresponding saturation signals and the corresponding margin values; adjusting brightnesses of the corresponding first luminance signals based on the first luminance signals and the corresponding control values and outputting second luminance signals with the adjusted brightnesses; and converting a color space based on the hue signals, the saturation signals, and the second luminance signals and outputting output image signals, each of which includes an R signal, a G signal, and a B signal.

By using the program, the quality of an image may be improved by improving contrast through selective adjustment of brightnesses based on input image signals.

According to an aspect of yet another exemplary embodiment, there is provided an image display device including an image signal adjusting unit for adjusting gradation of each of a plurality of pixels in input image signals; and an image display unit for displaying images based on the image signals adjusted by the image signal adjusting unit, wherein the image signal adjusting unit includes a first color space converting unit for converting a color space based on input image signals and outputting hue signals, saturation signals, and first luminance signals based on the input image signals; a margin value calculating unit for calculating margin values, which indicate the margins with respect to maximum brightnesses, for the corresponding hue signals; a control value set up unit for setting up control values for controlling the corresponding first luminance signals based on the corresponding saturation signals and the corresponding margin values; a brightness adjusting unit for adjusting brightnesses of the first luminance signals based on the first luminance signals and the corresponding control values and outputting second luminance signals with the adjusted brightnesses; and a second color space converting unit for converting a color space based on the hue signals, the saturation signals, and the second luminance signals and outputting image signals.

The image display device may improve the quality of an image by improving contrast through selective adjustment of brightness based on input image signals.

### BRIEF DESCRIPTION OF THE DRAWINGS

The above and other features and advantages will become more apparent by describing in detail exemplary embodiments thereof with reference to the attached drawings in which:

FIG. 1 is a graph for describing the calculation of margin values in an image signal processing device, according to an exemplary embodiment;

FIG. 2 is a graph showing an example of methods of setting up control values in the image signal processing device, according to an exemplary embodiment;

FIG. 3 is a graph for describing an example of maximum defining information according to an exemplary embodiment;

FIGS. 4A through 4E are diagrams showing a result of brightness adjustment in the image signal processing device, according to an exemplary embodiment;

FIG. 5 is a block diagram of a configuration of the image signal processing device according to an exemplary embodiment;

FIG. 6 is a flowchart of a method of processing image signals according to an exemplary embodiment;

FIG. 7 is a block diagram of a configuration of a display device according to an exemplary embodiment;

FIG. 8 is a diagram for describing a related art for correcting image signals based on a histogram of luminance signals based on the image signals;

FIG. 9 is a diagram for describing a related art for correcting image signals based on a histogram of luminance signals based on the image signals;

FIG. 10 is a diagram for describing a related art for correcting image signals based on a histogram of luminance signals based on the image signals;

FIGS. 11A through 11E are diagrams for describing problems in a related art for correcting image signals based on a histogram of luminance signals based on the image signals; and

FIGS. 12A through 12E are diagrams for describing a case in which the image shown in FIG. 11A is supersaturated by adjusting the saturation of colors, where the saturation of the image is doubled.

### DETAILED DESCRIPTION

Hereinafter, exemplary embodiments will be described in detail with reference to the attached drawings. Like reference numerals in the drawings denote like elements.

### An Approach for the Improvement of Contrast According to Exemplary Embodiments

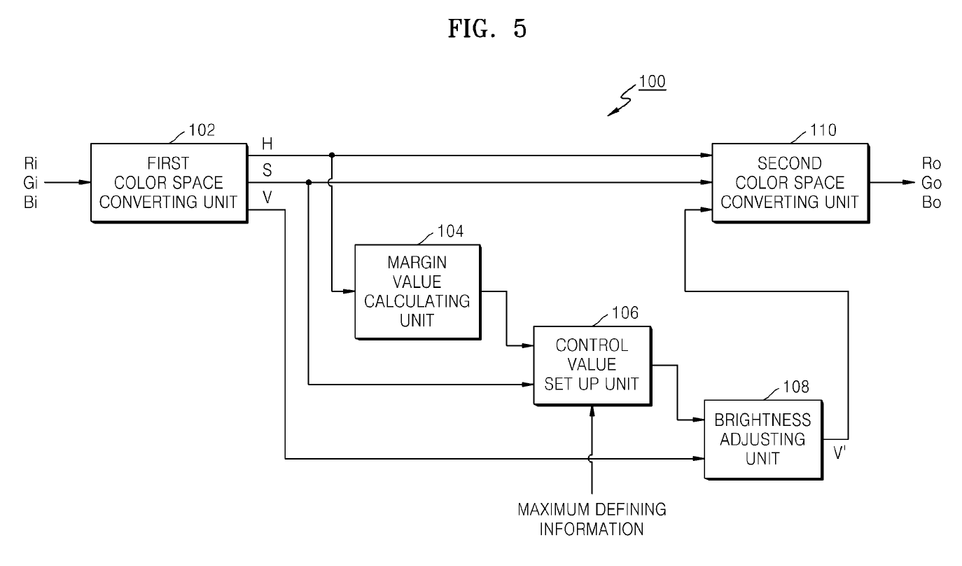

Prior to the description of the configuration of an image signal processing device 100 (shown in FIG. 5) according to an exemplary embodiment, an approach for the improvement of contrast in the image signal processing device 100 according to an exemplary embodiment will be described below.

Furthermore, although it is stated below that an image signal, which may also be referred hereinafter as ‘input image signal’, includes an R signal corresponding to the red component, a G signal corresponding to the green component, and a B signal corresponding to the blue component, it is understood that exemplary embodiments are not limited thereto. For example, the image signal processing device 100 may process image signals that are expressed in a different color space, such as a YCrCb color space, by converting the color space of the image signals into the RGB color space. Here, the image signals in exemplary embodiments may be related to still images or moving images.

### Abstract of the Approach According to Exemplary Embodiments

The image signal processing device 100 improves contrast by adjusting a brightness of each pixel based on values of hue and saturation of each of input image signals corresponding to each of the pixels. In detail, the image signal processing device 100 adjusts brightness based on the input image signals by calculating a margin value, which indicates the margin of brightness, for each of the hues, and determining an amount of controlling brightness based on the margin values and saturations calculated for each of the hues.

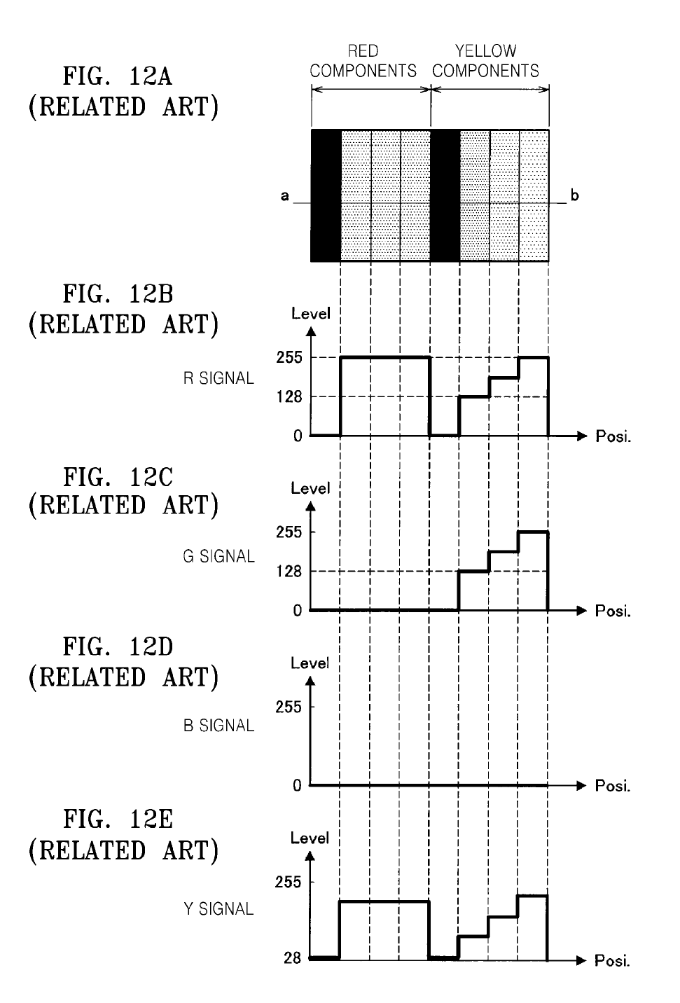

The image signal processing device 100 calculates the margin value for each of the hues according to the input image signals and adjusts the brightness of each of the pixels within a margin indicated by the margin values, with respect to luminance signals respectively corresponding to the pixels. Therefore, for example, the image signal processing device 100 may improve contrast and prevent the deterioration of image quality due to supersaturation shown in FIG. 12A.

Furthermore, the image signal processing device 100 adjusts the brightness of each of the pixels based on the hues and the saturations of the input image signals, as described above. Therefore, the image signal processing device 100 does not change hues of an image significantly (e.g., a change significant for a user to recognize the change of colors), unlike a conventional image signal processing device to which the technical configuration disclosed in Cited Reference 2 is applied.

Therefore, the image signal processing device 100 may improve the quality of images by improving the contrast of the images through selective adjustment of brightness based on input image signals.

### An Example of Image Processing According to Exemplary Embodiments

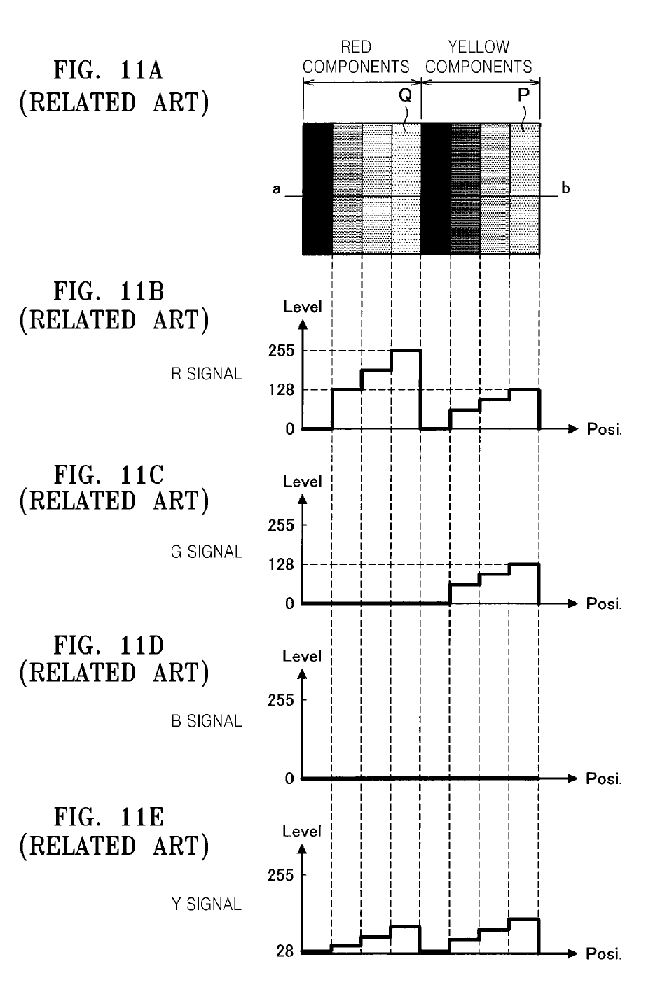

Next, a method of processing an image according to exemplary embodiments will be described in closer detail. The image signal processing device 100 improves the contrasts of images by performing, for example, processes (1) through (3) below with respect to input image signals. Hereinafter, image processing in the image signal processing device 100 will be described based on a case in which an image indicated by input image signals is the image shown in FIG. 11A.

Exemplary Process (1) First Conversion of Color Space

Based on the input image signals, each of which includes an R signal, a G signal, and a B signal, the image signal processing device 100 converts color spaces of each pixel (with respect to images signals corresponding to each of the pixels) into the hue, saturation, and value (HSV) color spaces of each of the pixels. Here, the image signal processing device 100 converts a color space of an image signal into the HSV color space for adjusting brightness based on hue and saturation, as described above.

As the image signal processing device 100 performs exemplary process (1), the input image signal is converted to a hue signal (referred hereinafter as a hue signal H) indicating the hue of the input image signal, a saturation signal (referred hereinafter as a saturation signal S) indicating the saturation of the input image signal, and a luminance signal (referred hereinafter as a first luminance signal V) of the input image signal. Here, the image signal processing device 100 may convert the input image signal, which includes the R signal, the G signal, and the B signal, into the hue signal H, the saturation signal S, and the first luminance signal V by using Mathematical Expressions 2 through 4 below, for example. In Mathematical Expressions 2 through 4 below, the R signal is indicated as “Ri,” the G signal is indicated as “Gi,” the B signal is indicated as “Bi,” the hue signal H is indicated as “H,” the saturation signal S is indicated as “S,” and the first luminance signal V is indicated as “V.” Furthermore, in Mathematical Expressions 2 through 4 below, maximum values of the R signal, the G signal, and the B signal of each of the image signals respectively corresponding to each of the pixels are indicated as “MAX,” whereas minimum values of the R signal, the G signal, and the B signal of each of the image signals respectively corresponding to each of the pixels are indicated as “MIN.”

$$\begin{matrix} [ Mathematical Expression 2 ] \\ H = \{ \begin{matrix}60 \times ( \frac{G i - B i}{MAX - MIN} ) & ( When MAX = R i ) \\ 60 \times ( 2 + \frac{R i - B i}{MAX - MIN} ) & ( When MAX = G i ) \\ 60 \times ( 4 + \frac{G i - R i}{MAX - MIN} ) & ( When MAX = B i ) \\ 0 & ( When MAX = 0 ) ,\end{matrix} \\ [ Mathematical Expression 3 ] \\ S = \{ \begin{matrix}0 ( When MAX = 0 ) \\ \frac{MAX - MIN}{MAX} ,\end{matrix} \\ [ Mathematical Expression 4 ] \\ V = MAX .\end{matrix}$$

Exemplary Process (2) Adjustment of Brightness

The image signal processing device 100 adjusts brightness based on the hue signal H, the saturation signal S, and the first luminance signal V converted through process (1), described above. A saturation signal of which the brightness is adjusted will be referred hereinafter as a second luminance signal V′. In detail, the image signal processing device 100 converts the first luminance signal V to the second luminance signal V′ through exemplary processes (2-1) through (2-2) described below.

Exemplary Process (2-1) Calculation of Margin Value

The image signal processing device 100 calculates margin values, which indicate the margin of brightness with respect to the maximum value, for each of the hues based on the hue signals H.

FIG. 1 is a graph for describing the calculation of margin values in the image signal processing device 100, according to an exemplary embodiment. Here, FIG. 1 shows the relationship between hues and brightness that are calculated based on hue signals H corresponding to image signals indicating the image shown in FIG. 11A. Furthermore, in FIG. 1, the horizontal axis indicates hue signals H [degree], whereas the vertical axis indicates brightness [%]. Here, although FIG. 1 shows brightness in percentage, exemplary embodiments are not limited thereto. For example, the image signal processing device 100 may indicate brightness within a range between 0.0 and 1.0.

The image signal processing device 100 detects hue components included in an image indicated by input image signals based on hue signals H and calculates a margin value for each of the hues based on a result of the detection. For example, in the case of the hue Ye of FIG. 1, it is clear that there is a 50% margin with respect to the maximum value (100%) at the hue Ye. The image signal processing device 100 calculates a margin value, which indicates, for example, “50” [%], with respect to the hue Ye.

The image signal processing device 100 calculates the margin value for the hue based on the result of the detection of the hue components included in the image indicated by the image signals. Furthermore, the units of expressing margin values according to exemplary embodiments are not limited to percentage. For example, the image signal processing device 100 may indicate brightness within a range between 0.0 and 1.0.

Exemplary Process (2-2) Setup of Control Value

[1] Setup of First Control Value

The image signal processing device 100 sets up a control value for adjusting a luminance signal based on a margin value calculated with respect to each of the hues in the exemplary process (2-1) and a saturation signal S.

FIG. 2 is a graph showing an example of methods of setting up control values in the image signal processing device 100, according to an exemplary embodiment. In FIG. 2, the horizontal axis indicates saturation signals S, whereas the vertical axis indicates control values.

Here, FIG. 2 shows an example of methods of setting up control values that are set up with respect to pixels corresponding to the hue Ye shown in FIG. 1. Furthermore, the image signal processing device 100 may set up control values with respect to pixels corresponding to other hues using the same method as described with reference to FIG. 2.

Furthermore, although FIG. 2 shows saturation signals S and control values in percentages, exemplary embodiments are not limited thereto. For example, the image signal processing device 100 may calculate control values, of which a mathematical expression is converted from percentages into values within a range between 0.0 and 1.0, according to saturation signals S.

The image signal processing device 100 calculates unique control values by performing the calculations shown in Mathematical Expression 5 below, for example, for each of the pixels based on margin values for each of the hues and saturation signals S that are calculated through the exemplary process (2-1) above. In Mathematical Expression 5, “y” indicates a control value, “p” indicates the margin value of a hue corresponding to a pixel to which the control value is to be set up, and “x” indicates a value of a saturation signal S.

$$y = 100 + p \cdot {( \frac{x}{100} )}^{2} ( 0 \leq p \leq 100 ) . \qquad [ Mathematical Expression 5 ]$$

For example, in the case where the image signal processing device 100 sets up a control value with respect to a pixel corresponding to the hue Ye shown in FIG. 1, since the margin value p is 50[%], the image signal processing device 100 may obtain the control value “100+50(x/100)²” by performing the calculation according to Mathematical Expression 5. Therefore, a control value according to a saturation signal S is uniquely set up with respect to the pixel.

Furthermore, it is understood that the image signal processing device 100 is not limited in all embodiments to the set up of control values according to Mathematical Expression 5. For example, in the case of processing control values and saturation signals S that are expressed as values within the range between 0.0 and 1.0, the image signal processing device 100 may calculate unique control values by performing the calculations shown in Mathematical Expression 6 below with respect to each of the pixels.

y=1.0+p·x²(0≦p≦1.0). [Mathematical Expression 6]

The image signal processing device 100 sets up control values for adjusting brightness within ranges of margins with respect to the maximum values of brightness by setting up control values for embodying non-linear correction, in which the emphasis of brightness is maximized when saturation is at the maximum as described above, with respect to each of the pixels, for example. Therefore, even if the image signal processing device 100 adjusts the first luminance signal V based on a control value, which is set up during the setting up of the first control signal, during the exemplary process (2-3) below, the deterioration of quality of an image due to saturation as shown in FIGS. 12A through 12E does not occur. Furthermore, it is understood that the calculations of control values in the image signal processing device 100 according to an exemplary embodiment are not limited to Mathematical Expressions 5 and 6.

[2] Setup of Second Control Value

The process for setting up control values in the image signal processing device 100, according to an exemplary embodiment, is not limited to the setup of the first control value described above. For example, the image signal processing device 100 may set up a control value with respect to each of the pixels based on margin values that are obtained for each of the hues in the exemplary process (2-1), saturation signals S, and maximum defining information including maximum values for defining the maximum of control values for each of the hues.

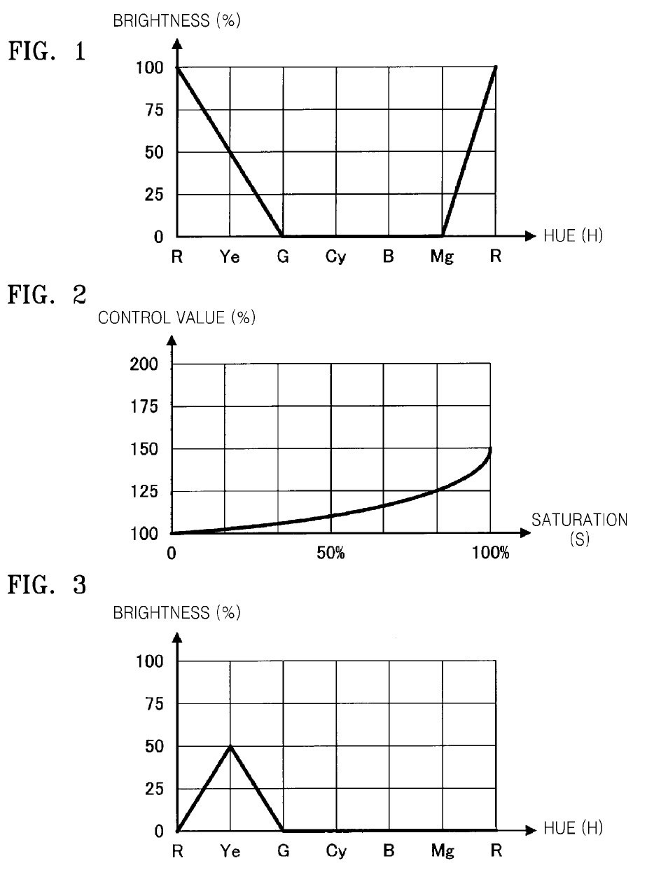

FIG. 3 is a graph for describing an example of maximum defining information according to an exemplary embodiment of the present invention. Here, in FIG. 3, the horizontal axis indicates hue signals H [degree], whereas the vertical axis indicates brightness [%], as in FIG. 1. Furthermore, the brightness [%] indicated by the vertical axis in FIG. 3 corresponds to the maximum value for defining the maximum of control values for each of the hues. Furthermore, although FIG. 3 shows brightness in percentage, it is understood that exemplary embodiments are not limited thereto. For example, the image signal processing device 100 may indicate brightness within a range between 0.0 and 1.0.

The image signal processing device 100 recognizes the maximum of control values for each of the hues by using the maximum defining information shown in FIG. 3. For example, since the maximum defining information shown in FIG. 3 defines the maximum 50[%] with respect to the hue Ye, the image signal processing device 100 recognizes that the maximum (maximum value defined by the maximum defining information) of control values set up with respect to pixels corresponding to the hue Ye is 150[%]. Furthermore, since the maximum 0[%] is set with respect to the hue R, the image signal processing device 100 recognizes that the maximum (maximum value defined by the maximum defining information) of control values set up with respect to pixels corresponding to the hue R is 100[%].

Here, maximum defining information may be information that is defined in advance and is recorded in a read-only memory (ROM). However, exemplary embodiments are not limited thereto. For example, the image signal processing device 100 may generate suitable maximum defining information based on an input from a user by using an operating console (described later).

The image signal processing device 100 sets up control values according to saturation signals S by selectively using a margin value for each of the hues obtained in the exemplary process (2-1) and maximum values defined in maximum defining information for each of the hues. In other words, the image signal processing device 100 sets up control values according to saturation signals S by selectively using either a margin value or maximum value as the value of “p” in Mathematical Expression 5 (or Mathematical Expression 6) for each of the colors, during the setup of second control values.

In detail, the image signal processing device 100 compares a margin value and a maximum value for each of the corresponding hues. Then, the image signal processing device 100 sets up a control value by selectively using margin values in the case where the maximum value is greater than the margin value, or by selectively using the maximum values in the case where the maximum value is less than the margin value. Accordingly, the image signal processing device 100 may set up control values within the range of margin with respect to the maximum value of brightness or according to the maximum defined by maximum defining information.

Therefore, even if the image signal processing device 100 adjusts the first luminance signal V based on a control value that is set up during the second control value setup exemplary process (2-3), the deterioration of quality of an image due to supersaturation, as shown in FIGS. 12A through 12E, does not occur. Furthermore, if a maximum value is set up based on an input from a user, for example, the image signal processing device 100 may adjust brightness as desired by the user. If a maximum value is defined in advance, the image signal processing device 100 may adjust brightness according to the corresponding setup.

The image signal processing device 100 may set up a control value for each of the pixels through the exemplary processes [1] and [2]. Furthermore, a method of calculating a control value in the image signal processing device 100 according to an exemplary embodiment is not limited thereto.

Exemplary Process (2-3) Adjustment of Brightness (Calculation of Second Luminance signal V′)

The image signal processing device 100 calculates a second luminance signal V′ corresponding to brightness adjusted based on the control value obtained in the exemplary process (2-2) above and the first luminance signal V, for each of the pixels. Here, the image signal processing device 100 uses the control signal as a factor and multiplies a first luminance signal V by a control value for each of the pixels to calculate the second luminance signal V′.

Exemplary Process (3) Second Conversion of Color Space

The image signal processing device 100 converts the color space of each of the pixels into the color space corresponding to the input image signal (e.g., the RGB color space) based on hue signals H, saturation signals S, and second luminance signals V′. Here, the image signal processing device 100 may convert the hue signals H, the saturation signals S, and the second luminance signals V′ into R signals, G signals, and B signals, respectively, by using Mathematical Expressions 7 through 15 below, for example. In Mathematical Expression 7 through 15, the R signal is indicated by “Ro.” the G signal is indicated by “Go.” the B signal is indicated by “Bo.” the hue signal H is indicated by “H.” the saturation signal S is indicated by “S.” and the second luminance signal V′ is indicated by “V′.”

<When Saturation Signal S=0>

R=G=B=V, [Mathematical Expression 7]

<When Saturation Signal S≠0>

$$\begin{matrix}I = [ \frac{H}{60} ] , & [ Mathematical Expression 8 ] \\ F = H - I , & [ Mathematical Expression 9 ] \\ M = V \cdot ( 1 - S ) , & [ Mathematical Expression 10 ] \\ N = V \cdot ( 1 - S \cdot F ) , & [ Mathematical Expression 11 ] \\ N = V 1 - S \cdot ( 1 - F ) , & [ Mathematical Expression 12 ] \\ Ro = \{ \begin{matrix}V & ( l = 0 ) \\ N & ( l = 1 ) \\ M & ( l = 2 ) \\ M & ( l = 3 ) \\ K & ( l = 4 ) \\ V & ( l = 5 ) ,\end{matrix} & [ Mathematical Expression 13 ] \\ Go = \{ \begin{matrix}K & ( l = 0 ) \\ V & ( l = 1 ) \\ V & ( l = 2 ) \\ N & ( l = 3 ) \\ M & ( l = 4 ) \\ M & ( l = 5 ) ,\end{matrix} & [ Mathematical Expression 14 ] \\ Bo = \{ \begin{matrix}M & ( l = 0 ) \\ M & ( l = 1 ) \\ K & ( l = 2 ) \\ V & ( l = 3 ) \\ V & ( l = 4 ) \\ N & ( l = 5 ) ,\end{matrix} & [ Mathematical Expression 15 ]\end{matrix}$$

For example, the image signal processing device 100 may output the R signals (also referred hereinafter as ‘Ro signals’), the G signals (also referred hereinafter as ‘Go signal’), and the B signals (also referred hereinafter as ‘Bo signals’), of which the brightness is adjusted for each of the pixels, by performing the calculations shown in Mathematical Expressions 7 through 15 above with respect to each of the pixels.

The image signal processing device 100 according to an exemplary embodiment adjusts the brightness of the input image signals for each of the pixels by performing the exemplary process (1) (first conversion of color space), the exemplary process (2) (adjustment of brightness), and the exemplary process (3) (second conversion of color space), described above. Here, the image signal processing device 100 obtains a margin value for each of the hues in the exemplary process (2) and sets up a control value for adjusting the luminance signal within the margin range with respect to the maximum value of brightness defined by the margin value for each of the pixels. Furthermore, the image signal processing device 100 adjusts a first luminance signal V for each of the pixels based on the setup control value. In other words, the image signal processing device 100 changes the amount of adjusting brightness within the margin range with respect to the maximum value of brightness calculated based on hue signals H for each of the pixels. Furthermore, the image signal processing device 100 outputs the Ro signal, the Go signal, and the Bo signal based on a hue signal H, a saturation signal S, and a second luminance signal V′ corresponding to adjusted brightness, for each of the pixels. Therefore, the image signal processing device 100 may embody the approach according to exemplary embodiments by performing the exemplary processes (1) through (3).

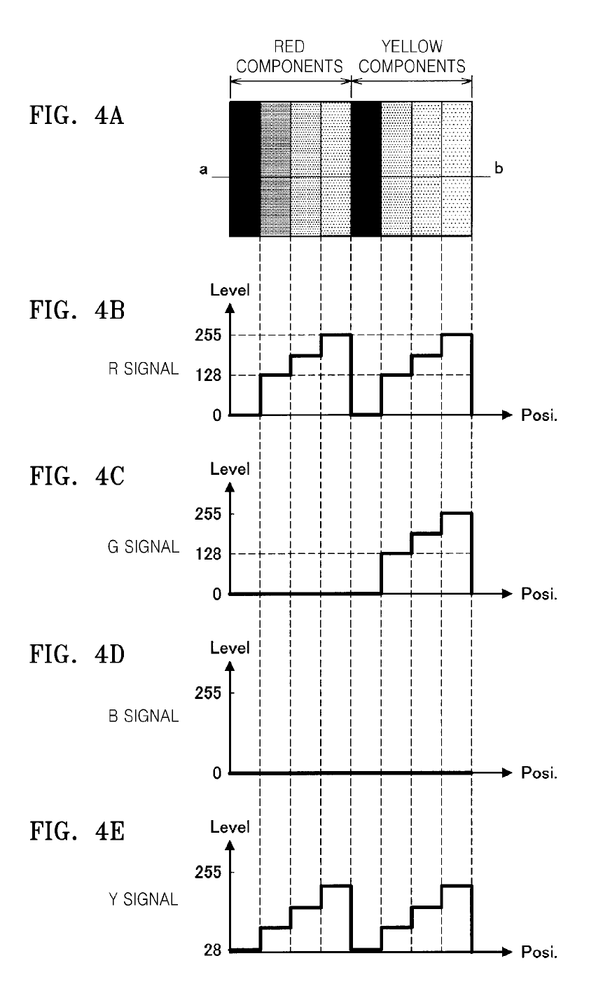

FIGS. 4A through 4E are diagrams showing a result of brightness adjustment in the image signal processing device 100, according to an exemplary embodiment of the present invention. Here, FIG. 4 shows an example of results of a processing of the input image signals indicating the image shown in FIG. 11A by the image signal processing device 100. Furthermore, FIG. 4A shows an example of images indicated by image signals (output image signals) output by the image signal processing device 100, and FIGS. 4B through 4E show an R signal (Ro signal), a G signal (Go signal), a B signal (Bo signal), and a Y signal at each of the locations on a line a-b shown in FIG. 4A, respectively.

As stated above, the image signal processing device 100 changes the amount of adjusting brightness within the margin range with respect to the maximum value of brightness calculated based on hue signals H for each of the pixels. As shown in FIGS. 4B through 4E, the image signal processing device 100 may improve the contrast of the right half of an image without deteriorating red gradation levels shown in FIG. 12B.

The image signal processing device 100 may improve the contrast of images and improve the quality of the images by selectively adjusting brightness based on input image signals by performing the exemplary processes (1) through (3), as described above. However, it is understood that processes for embodying the approach according to exemplary embodiments of the present invention are not limited thereto. For example, the image signal processing device 100 may output hue signals H, saturation signals S, and second luminance signals V′ corresponding to adjusted brightness as output image signals without performing the exemplary process (3) (i.e., second conversion of color space). In this case, the image signal processing device 100 may also selectively adjust brightness based on input image signals, and thus the quality of images may be improved by adjusting the contrast of the images.

### Image Signal Processing Device 100 according to Exemplary Embodiments

Next, a configuration of the image signal processing device 100 capable of performing the exemplary processes (1) (i.e., first conversion of color space) through (3) (i.e., second conversion of color space) with respect to the approach according to exemplary embodiments will be described.

Hereinafter, it is assumed that image signals input to the image signal processing device 100 are, as an example, digital signals used for digital broadcasting. Furthermore, the image signals input to the image signal processing device 100 may be transmitted from, as an example, a broadcasting station. However, it is understood that exemplary embodiments are not limited thereto. For example, the image signals input to the image signal processing device 100 may be externally received via a network, such as a local area network (LAN), or the image signals may be read out from image files or video files stored in a storage unit (not shown) included in the image signal processing device 100.

FIG. 5 is a block diagram of a configuration of the image signal processing device 100 according to an exemplary embodiment. Here, in FIG. 5, the input image signals are indicated by Ri, Gi, and Bi, whereas output image signals (image signals with adjusted brightness) are indicated by Ro, Go, and Bo.

Referring to FIG. 5, the image signal processing device 100 includes a first color space converting unit 102, a margin value calculating unit 104, a control value set up unit 106, a brightness adjusting unit 108, and a second color space converting unit 110.

The image signal processing device 100 may also include a control unit (not shown), which includes a micro processing unit (MPU) and/or various processing circuits and is capable of controlling the entire image signal processing device 100, a read-only memory (ROM) (not shown) for storing programs and control data, such as calculation parameters, used by the control unit, a random access memory (RAM) (not shown) for temporarily storing programs executed by the control unit, a receiving unit (not shown) for receiving image signals transmitted by a source (e.g. a broadcasting station), a storage unit (not shown) for storing image files and/or video files, an operating console (not shown) by which a user may operate the image signal processing device 100, and a communication unit (not shown) by which the image signal processing device 100 may communicate with external devices (not shown). For example, the image signal processing device 100 establishes connections among each of the units via buses, which are paths for data transmission. Furthermore, the control unit may function as the first color space converting unit 102, the margin value calculating unit 104, the control value set up unit 106, the brightness adjusting unit 108, and the second color space converting unit 110, which are described below.

Here, the storage unit may include magnetic recording mediums (e.g. a hard disk), non-volatile memories (e.g. an electrically erasable and programmable read only memory (EEPROM), flash memory, a magnetoresistive random access memory (MRAM), a ferroelectric random access memory (FeRAM), a phase change random access memory (PRAM)), or magneto optical disks. However, exemplary embodiments are not limited thereto. Furthermore, the operating console may include input devices (e.g. a keyboard and a mouse), buttons, and/or directional keys. However, exemplary embodiments are not limited thereto.

Furthermore, the image signal processing device 100 and an external device (not shown) may be connected to each other either physically via universal serial bus (USB) ports or IEEE 1394 ports, or wirelessly via a wireless universal serial bus (WUSB) or IEEE 802.11. Furthermore, the image signal processing device 100 and an external device (not shown) may be connected to each other via a network. Examples of networks may include wired networks (e.g., a LAN or a wide area network (WAN)), wireless networks (e.g., a multiple-input multiple-output (MIMO) network and wireless local area network (WLAN)), and Internet networks using protocols such as a transmission control protocol/internet protocol (TCP/IP). However, it is understood that exemplary embodiments are not limited thereto. As described above, the communication unit includes an interface for connection to an external device (not shown).

The first color space converting unit 102 performs the exemplary process (1) (i.e., first conversion of color space). In other words, the first color space converting unit 102 converts input image signals (Ri signals, Gi signals, and Bi signals) into hue signals H, saturation signals S, and first luminance signals V. Here, the first color space converting unit 102 converts the input image signal, which includes the Ri signal, the Gi signal, and the Bi signal, into the hue signal H, the saturation signal S, and the first luminance signal V, respectively, according to Mathematical Expressions 2 through 4 above, for example. However, it is understood that exemplary embodiments are not limited thereto.

Here, the first color space converting unit 102 may include an exclusive calculating circuit for performing the calculations of Mathematical Expressions 2 through 4 above to convert the input image signals into the hue signals H, the saturation signals S, and the first luminance signals V. However, it is understood that exemplary embodiments are not limited thereto. For example, the first color space converting unit 102 may include an MPU or a universal calculating circuit.

The margin value calculating unit 104 performs the exemplary process (2-1) (i.e., calculation of margin values). In other words, the margin value calculating unit 104 calculates a margin value, which indicates the margin with respect to the maximum value of brightness, with respect to each of the hues based on hue signals H. Here, the margin value calculating unit 104 may include an exclusive calculating circuit for performing the exemplary process (2-1) (i.e., calculation of margin value), for example. However, it is understood that exemplary embodiments are not limited thereto. For example, the margin value calculating unit 104 may include an MPU or a universal calculating circuit.

The control value set up unit 106 performs the exemplary process (2-2) (i.e., setup of control values). In other words, the control value set up unit 106 sets up a control value for adjusting a luminance signal based on a margin value calculated by the margin value calculating unit 104 for each of the hues and a saturation signal S (i.e., setup of first control value). Furthermore, the control value set up unit 106 may set up a control value based on a margin value calculated by the margin value calculating unit 104 for each of the colors, the saturation signal S, and maximum defining information (i.e., setup of second control value).

Here, the control value set up unit 106 may include an exclusive calculating circuit for performing the calculations of Mathematical Expression 5 (or Mathematical Expression 6) above to output the control value based on the margin value or maximum value and the saturation signal S. However, it is understood that exemplary embodiments are not limited thereto. For example, the control value set up unit 106 may include an MPU or a universal calculating circuit.

The brightness adjusting unit 108 performs the exemplary process (2-3) (i.e., adjustment of brightness). In other words, the brightness adjusting unit 108 outputs a second luminance signal V′ based on a control value output by the control value set up unit 106 and a first luminance signal V for each of the pixels. Here, the brightness adjusting unit 108 includes a multiplication circuit (calculating circuit) for multiplying the control value by the first luminance signal V and outputs the second luminance signal V′ for each of the pixels. However, it is understood that exemplary embodiments are not limited thereto. For example, the brightness adjusting unit 108 may include an MPU or a universal calculating circuit.

The second color space converting unit 110 performs the exemplary process (3) (i.e., second conversion of color space). In other words, the second color space converting unit 110 converts hue signals H, saturation signals S, and second luminance signals V′ into output image signals (Ro signals, Go signals, and Bo signals). Here, the second color space converting unit 110 converts the hue signal H, the saturation signal S, and the second luminance signal V′ into the Ro signal, the Go signal, and the Bo signal, respectively, according to Mathematical Expressions 7 through 15 above, for example. However, it is understood that exemplary embodiments are not limited thereto.

Here, the second color space converting unit 110 includes an exclusive calculating circuit for performing the calculations of Mathematical Expressions 7 through 15 above to convert the hue signals H, the saturation signals S, and the second luminance signals V′ into the Ro signals, the Go signals, and the Bo signals, respectively. However, it is understood that exemplary embodiments are not limited thereto. For example, the second color space converting unit 110 may include an MPU or a universal calculating circuit. Furthermore, the second color space converting unit 110 and the first color space converting unit 102 may form a common calculating circuit (or a configuration in which each of the second color space converting unit 110 and the first color space converting unit 102 includes portions of a calculating circuit).

The image signal processing device 100 includes the first color space converting unit 102, the margin value calculating unit 104, the control value set up unit 106, the brightness adjusting unit 108, and the second color space converting unit 110 to perform the exemplary process (1) (i.e., first conversion of color space), the exemplary process (2) (i.e., adjustment of brightness), and the exemplary process (3) (i.e., second conversion of color space). Therefore, the image signal processing device 100 may adjust the brightness of an input image signal in each of the pixels, and output image signals with the adjusted brightness.

Furthermore, the configuration of an image signal processing device 100 according to an exemplary embodiment is not limited to the configuration shown in FIG. 5. For example, an image signal processing device 100 according to another exemplary embodiment may have a configuration without the second color space converting unit 110, that is, a configuration that does not perform the exemplary process (3) (i.e., second conversion of color space). In this case, the image signal processing device 100 may still selectively adjust brightness based on input image signals.

Accordingly, the image signal processing device 100 according to an exemplary embodiment adjusts the brightness of input image signals for each of the pixels by performing the exemplary process (1) (i.e., first conversion of color space), the exemplary process (2) (i.e., adjustment of brightness), and the exemplary process (3) (i.e., second conversion of color space). Here, the image signal processing device 100 calculates a margin value of each of the colors in the exemplary process (2) and sets up a control value for adjusting a luminance signal within the margin range with respect to the maximum value of brightness defined by the margin value with respect to each of the pixels. Furthermore, the image signal processing device 100 adjusts the brightness of a first luminance signal V for each of the pixels based on a control value. In other words, the image signal processing device 100 changes amounts of adjusting brightness within the margin range with respect to the maximum value of brightness calculated based on hue signals H for each of the pixels. Therefore, even if the image signal processing device 100 adjusts the first luminance signal V based on the control value, the deterioration of quality of an image due to supersaturation as shown in FIGS. 12A through 12E does not occur. Therefore, the image signal processing device 100 may improve the quality of an image by improving contrast through selective adjustment of brightness based on input image signals.

Although the image signal processing device 100 is described above as an exemplary embodiment, all exemplary embodiments are not limited thereto. Some exemplary embodiments may be applied to various devices including display devices (e.g. a CRT display, an organic EL display, an FED, an LCD, and a PDP), computers (e.g. a personal computer (PC) and a server), and mobile communication devices (e.g. a mobile phone). Furthermore, the image signal processing device 100 may also be embodied as an integrated circuit (IC) chip in which the components as shown in FIG. 5 are integrated. The application of the image signal processing device 100 to a display device will be described below.

(Program Regarding Image Signal Processing Device)

Quality of an image may be improved by improving contrast through selective adjustment of brightness based on input image signals by using a program which enables a computer to operate as an image signal processing device according to an exemplary embodiment.

### Method of Processing Image Signals According to Exemplary Embodiments

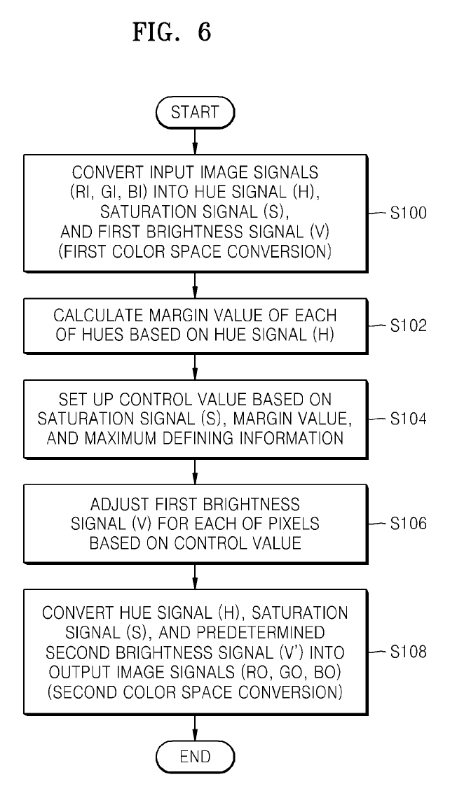

Next, a method of processing image signals according to an exemplary embodiment will be described. FIG. 6 is a flowchart of a method of processing image signals according to an exemplary embodiment. Furthermore, although it is stated below that the image signal processing device 100 performs the method of processing image signals shown in FIG. 6, it is understood that all exemplary embodiments are not limited thereto, and the method may be applied to a display device according to an exemplary embodiment described below.

The image signal processing device 100 converts an input image signal, which includes an Ri signal, a Gi signal, and a Bi signal, into a hue signal H, a saturation signal S, and a first luminance signal V, according to Mathematical Expressions 2 through 4 above, for example, in operation S100 (i.e., first conversion of color space). However, it is understood that exemplary embodiments are not limited thereto.

The image signal processing device 100 calculates margin values for each of the hues based on the converted hue signal H in operation S102. Here, the image signal processing device 100 detects hue components included in an image indicated by the input image signals based on the hue signals H and calculates the margin value based on a result of a detection of hue components.

The image signal processing device 100 sets up a control value for each of the pixels based on saturation signals S, which are converted in operation S100, margin values, which are calculated in operation S102, and maximum defining information in operation S104. Here, the image signal processing device 100 sets up control values according to the saturation signals S by selectively using the margin value for each of the hues obtained in the exemplary process (2-1) and maximum values defined in the maximum defining information for each of the hues (i.e., setup of second control value).

Furthermore, the process for setting up control values in the image signal processing device 100 according to an exemplary embodiment is not limited to operation 104. For example, the image signal processing device 100 may set up control values with respect to each of the pixels based only on the saturation signals S, which are converted in operation S100, and the margin values, which are calculated in operation S102 (setup of first control value).

The image signal processing device 100 adjusts first luminance signals V, which are converted in operation S100, with respect to each of the pixels based on control values that are set up with respect to each of the pixels in operation S104, in operation S106. Here, the image signal processing device 100 multiplies the first luminance signal V by the control value for each of the pixels to adjust the first luminance signal V. However, it is understood that exemplary embodiments are not limited thereto.

The image signal processing device 100 converts hue signals H and saturation signals S, which are converted in operations S100, and second luminance signals V′, which are adjusted in operations S106, into output image signals (Ro signals, Go signals, and Bo signals) in operation S108 (i.e., second conversion of color space). Here, the image signal processing device 100 converts the hue signal H, the saturation signal S, and the second luminance signal V′ into the Ro signal, the Go signal, and the Bo signal, respectively, according to Mathematical Expressions 7 through 15 above, for example. However, it is understood that exemplary embodiments are not limited thereto.

The image signal processing device 100 may improve the quality of images by selectively adjusting brightness based on input image signals according to the method of processing image signals described with reference to FIG. 6. However, it is understood that a method of processing image signals according to exemplary embodiments is not limited to the method described with reference to FIG. 6. For example, the image signal processing device 100 may output the hue signals H, which are converted in operation S100, the saturations signals S, and the second luminance signals V′, which are converted in operation S106, as output image signals without performing operation 5108 shown in FIG. 6. In this case, the image signal processing device 100 may still selectively adjust the brightness based on the input image signal, and thus the quality of images may be improved by improving contrast.

### Display Device According to Exemplary Embodiments

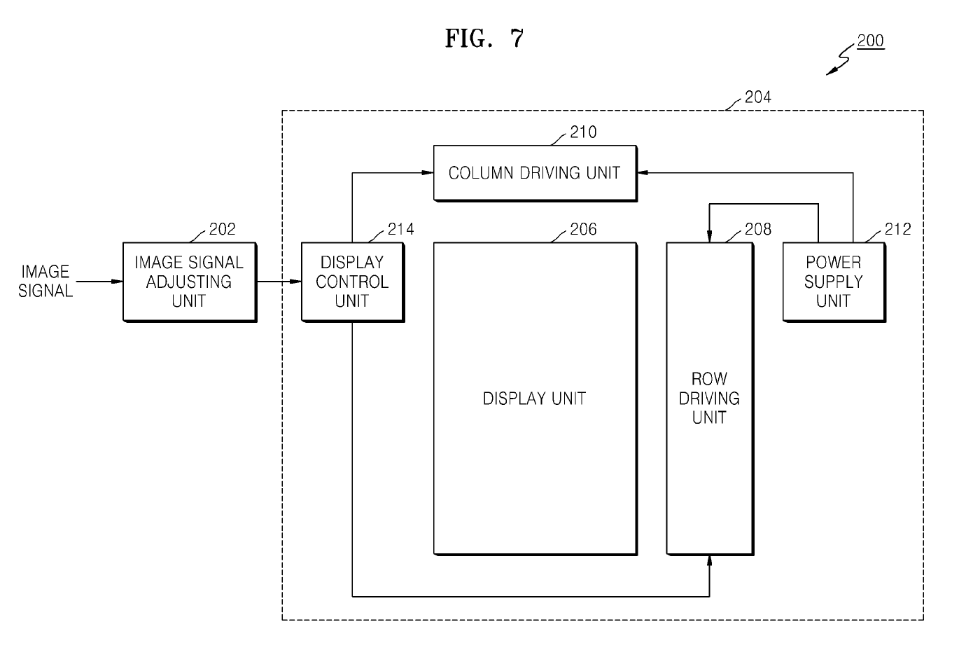

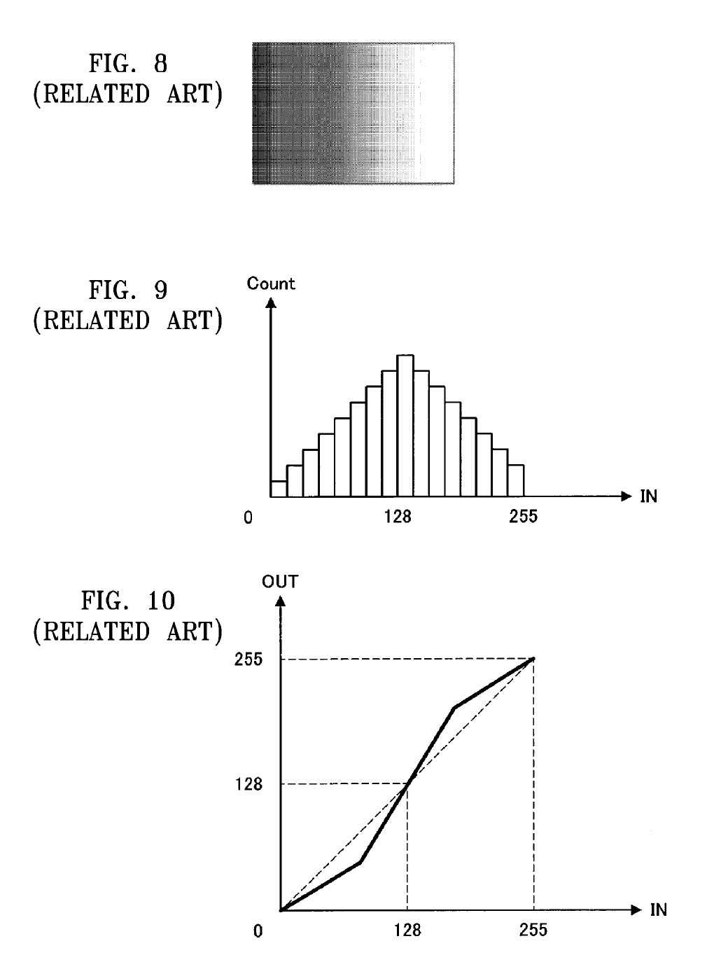

Next, a display device 200 to which an image signal processing device according to an exemplary embodiment is applied will be described below. FIG. 7 is a block diagram of a configuration of the display device 200 according to an exemplary embodiment. Here, the display device 200 shown in FIG. 7 is merely an example of display device according to exemplary embodiments, and all exemplary embodiments are not limited to thereto. Furthermore, it is assumed below, as an example, that image signals input to the display device 200 are the same image signals (Ri signals, Gi signals, and Bi signals) input to the image signal processing device 100 as shown in FIG. 5.

Referring to FIG. 7, the display device 200 includes an image signal adjusting unit 202 and an image display unit 204. Furthermore, the display device 200 may also include a control unit (not shown), which includes an MPU and/or various processing circuits and is capable of controlling the entire display device 200, a ROM (not shown) for storing programs and control data, such as calculation parameters, used by the control unit, a RAM (not shown) for temporarily storing programs executed by the control unit, a receiving unit (not shown) for receiving image signals transmitted by a source (e.g., a broadcasting station), a storage unit (not shown) for storing data to be displayed for a user interface, an operating console (not shown) by which a user may operate the display device 200, and a communication unit (not shown) by which the image signal processing device 100 may communicate with external devices (not shown). For example, the display device 200 establishes connections among each of the units via buses, which are paths for data transmission.

Here, the storage unit may include magnetic recording mediums (e.g., a hard disk), non-volatile memories (e.g., an EEPROM, flash memory, a MRAM, a FeRAM, or a PRAM), or magneto optical disks. However, exemplary embodiments are not limited thereto. Furthermore, the operating console may include input devices (e.g., a keyboard and a mouse), buttons, and/or directional keys. However, exemplary embodiments are not limited thereto.

Furthermore, the display device 200 and an external device (not shown) may be connected to each other either physically via USB ports, DVI ports, or HDMI ports, or wirelessly via WUSB. Furthermore, the display device 200 and an external device (not shown) may be connected to each other via a wired network or a wireless network. Therefore, the communication unit includes an interface for connection to an external device (not shown).

The image signal adjusting unit 202 may employ the same configuration as the configuration of the image signal processing device 100 according to an exemplary embodiment of the present invention as shown in FIG. 5, for example. Therefore, the image signal adjusting unit 202 outputs image signals (Ro signals, Go signals, and Bo signals) of which contrasts are improved through selective adjustment of brightness.

The image display unit 204 displays images based on image signals adjusted by the image signal adjusting unit 202.

[Example of Configuration of Image Display unit 204]

The image display unit 204 includes a display unit 206, a row driving unit 208, a column driving unit 210, a power supply unit 212, and a display control unit 214.

The display unit 206 displays images indicated by image signals. The display unit 206 includes, for example, a plurality of pixels that are arranged in a matrix. For example, a display unit for displaying images of standard definition (SD) resolution includes at least 680×480=307200 (data lines×scan lines) pixels, and, in the case where each of the pixel includes sub-pixels including an R pixel, a G pixel, and a B pixel for displaying colors, the display unit includes 640×480×3=921600 (data lines×scan lines×sub-pixels) sub-pixels. In the same regard, a display unit for displaying images of high definition (HD) resolution includes 1920×1080 pixels, and, in the case of displaying colors, the display unit includes 1920×1080×3 sub-pixels.

Furthermore, the display unit 206 may further include, for example, a pixel circuit (not shown) for controlling the amount of voltage/current applied to each of the pixels. The pixel circuit may include a switching device and a driving device, which are for controlling the amount of current according to applied scan signals and voltage signals, for example, and may include a capacitor for maintaining voltage signals. The switching device and the driving device are formed, for example, of thin film transistors (TFTs).

The row driving unit 208 and the column driving unit 210 apply voltages signals to a plurality of pixels in the display unit 206, such that each of the pixels emits light. Here, one of the row driving unit 208 and the column driving unit 210 may apply voltage signals (scan signals) for turning pixels on or off, and the other one of the row driving unit 208 and the column driving unit 210 may apply voltage signals (image signals) according to images to be displayed.

Furthermore, examples of methods of driving the row driving unit 208 and the column driving unit 210 may include a dot-sequential drive scanning method, according to which each of the pixels in columns and rows independently emits light, a line-sequential drive scanning method, according to which a column of pixels emit light at a time, and a plane-sequential drive scanning method, according to which all pixels in columns and rows simultaneously emit light. Furthermore, although the image display unit 204 of the display device 200 shown in FIG. 7 includes two driving units, that is, the row driving unit 208 and the column driving unit 210, it is understood that a display device according to another exemplary embodiment may include one driving unit.

The power supply unit 212 supplies power to the row driving unit 208 and the column driving unit 210, such that voltages are applied to the row driving unit 208 and the column driving unit 210. Furthermore, the magnitude of voltages applied to the row driving unit 208 and the column driving unit 210 by the power supply unit 212 varies according to image signals adjusted by the image signal adjusting unit 202.

The display control unit 214 includes, for example, an MPU. The display unit 214 inputs control signals to one of the row driving unit 208 and the column driving unit 210 to apply voltages for turning pixels on or off according to image signals adjusted by the image signal adjusting unit 202, and inputs image signals to the other one of the row driving unit 208 and the column driving unit 210. Furthermore, the display control unit 214 may also control the power supply unit 212 to supply power to the row driving unit 208 and the column driving unit 210 according to image signals adjusted by the image signal adjusting unit 202.

The display unit 200 according to an exemplary embodiment has the configuration as shown in FIG. 7 for adjusting input image signals and displaying images indicated by the adjusted image signals based on the adjusted image signals. Furthermore, it is understood that a configuration of the display unit 200 according to an exemplary embodiment is not limited to the configuration shown in FIG. 7.

As described above, the display unit 200 according to an exemplary embodiment includes the image signal adjusting unit 202, which has the same operations and the same configuration as the image signal processing device 100 described above with reference to FIG. 5. Therefore, the display unit 200 may adjust the brightness of image signals for each of the pixels. Furthermore, the display unit 200 displays images indicated by image signals (output image signals) with the adjusted brightness based on the image signals with adjusted luminance signals. Therefore, the display unit 200 may improve the quality of images by improving contrasts through selective adjustment of brightness based on input image signals.

Furthermore, although the display unit 200 is described above as an exemplary embodiment, all exemplary embodiments are not limited thereto. For example, exemplary embodiments may be applied to self light-emitting display devices (e.g., a CRT display, an organic EL display, an FED, and a PDP), backlight display devices (e.g., an LCD), and a television module for receiving television broadcasting. Furthermore, exemplary embodiments may be applied to various devices, such as computers (e.g., a PC and a server) and mobile communication devices (e.g., a mobile phone).

(Program Regarding Display Device)

The quality of an image may be improved by improving contrast through selective adjustment of brightness based on input image signals by using a program which enables a computer to operate as an image signal processing device according to an exemplary embodiment.

While the present invention has been particularly shown and described with reference to exemplary embodiments thereof, it will be understood by those of ordinary skill in the art that various changes in form and details may be made therein without departing from the spirit and scope of the present invention as defined by the following claims.

For example, although it is stated above that a program (i.e., computer program), which enables a computer to operate as an image signal processing device according to an exemplary embodiment, is provided, a computer-readable recording medium having recorded thereon the program may also be provided by exemplary embodiments. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Exemplary embodiments may also be realized as a data signal embodied in a carrier wave and comprising the program readable by a computer and transmittable over the Internet. Moreover, while not required in all exemplary embodiments, one or more units of the image signal processing device 100 can include a processor or microprocessor executing a computer program stored in a computer-readable medium or transmitted over a carrier wave. Also, the computer program may be transmitted over a computer-readable transmission medium, such as a carrier wave, and received and implemented in general-use digital computers that execute the programs.

The configurations described above are examples of embodiments of the present invention, and thus the configurations belong to the technical scope of the present invention.

What is claimed is:

1. A method of processing an image, the method comprising:
converting a color space based on input image signals respectively corresponding to a plurality of pixels of the image and outputting hue signals, saturation signals, and first luminance signals for the plurality of pixels of the image based on the input image signals;
calculating margin values indicating margins with respect to maximum brightnesses for the corresponding hue signals;
setting up control values for controlling the first luminance signals based on the corresponding saturation signals and the corresponding margin values;
adjusting brightnesses of the first luminance signals based on the first luminance signals and the corresponding control values and outputting second luminance signals with the adjusted brightnesses; and
converting a color space based on the hue signals, the saturation signals, and the second luminance signals and outputting output image signals having the converted color space.

2. The method of claim 1, wherein the calculating of the margin values comprises:
detecting hue components included in the image indicated by the input image signals based on the hue signals; and
calculating the margin values based on a result of the detecting of the hue components.

3. The method of claim 1, wherein the setting up of the control values comprises:
setting up the control values by selectively using the corresponding margin values for the hue signals and corresponding maximum values defined in maximum defining information for the hue signals.

4. The method of claim 3, wherein the setting up of the control values by selectively using the corresponding margin values for the hue signals comprises:
selectively using the margin values if the corresponding maximum values are greater than the corresponding margin values; and
selectively using the maximum values if the corresponding maximum values are less than the corresponding margin values.

5. The method of claim 1, wherein each of the input image signals and the output image signals comprises an R signal corresponding to a red hue, a G signal corresponding to a green hue, and a B signal corresponding to a blue hue.

6. The method of claim 1, wherein the converting of the color space based on the input image signals comprises:
converting each input image signal to the corresponding hue signal according to:
$$H = \{ \begin{matrix}60 \times ( \frac{G i - B i}{MAX - MIN} ) & ( When MAX = R i ) \\ 60 \times ( 2 + \frac{R i - B i}{MAX - MIN} ) & ( When MAX = G i ) \\ 60 \times ( 4 + \frac{G i - R i}{MAX - MIN} ) & ( When MAX = B i ) \\ 0 & ( When MAX = 0 ) ;\end{matrix}$$
converting each input image signal to the corresponding saturation signal according to:
$$S = \{ \begin{matrix}0 ( When MAX = 0 ) \\ \frac{MAX - MIN}{MAX}\end{matrix} ; and$$
converting each input image signal to the corresponding first luminance signal according to:
V=MAX,
where Gi is a green hue signal of the input image signal, Bi is a blue hue signal of the input image signal, Ri is a red hue signal of the input image signal, MAX is a maximum value of the R signal, the G signal, and the B signal, MIN is a minimum value of the R signal, the G signal, and the B signal, H is the hue signal, S is the saturation signal, and V is the first luminance signal.

7. The method of claim 1, wherein the setting up of the control values comprises determining each control value according to:
$$y = 100 + p \cdot {( \frac{x}{100} )}^{2} ( 0 \leq p \leq 100 ) ,$$
where y indicates the control value, p indicates the corresponding margin value, and x indicates a value of the corresponding saturation signal.

8. The method of claim 1, wherein the setting up of the control values comprises determining each control value according to:
y=1.0+p·x²(0≦p≦1.0),
where y indicates the control value, p indicates the corresponding margin value, and x indicates a value of the corresponding saturation signal.

9. An image signal processing device comprising:
a first color space converting unit which converts a color space based on input image signals and which outputs hue signals, saturation signals, and first luminance signals for the plurality of pixels of an image based on the input image signals;
a margin value calculating unit which calculates margin values indicating margins with respect to maximum brightnesses for the corresponding hue signals;
a control value set up unit which sets up control values for controlling the corresponding first luminance signals based on the corresponding saturation signals and the corresponding margin values;
a brightness adjusting unit which adjusts brightnesses of the first luminance signals based on the first luminance signals and the corresponding control values, and which outputs second luminance signals with the adjusted brightnesses; and
a second color space converting unit which converts a color space based on the hue signals, the saturation signals, and the second luminance signals and which outputs output image signals having the converted color space.

10. The image signal processing device of claim 9, wherein each of the input image signals and the output image signals comprises an R signal corresponding to a red hue, a G signal corresponding to a green hue, and a B signal corresponding to a blue hue.

11. The image signal processing device of claim 9, wherein the brightness adjusting unit adjusts the brightnesses of the first luminance signals by multiplying the corresponding control values by the first luminance signals.

12. The image signal processing device of claim 9, wherein:
the control value set up unit sets up the control values based on maximum defining information including maximum values for defining maximums of control values for the corresponding hue signals; and
the control value set up unit compares the margin values and the maximum values, and sets up the control values by selectively using the corresponding margin values if the corresponding maximum values are greater than the corresponding margin values and sets up the control values by selectively using the corresponding maximum values if the corresponding maximum values are less than the corresponding margin values.

13. A computer-readable recording medium storing a computer program implemented by a computer to execute a method of processing an image, the method comprising:
converting a color space based on input image signals respectively corresponding to a plurality of pixels of the image, each of which comprises an R signal corresponding to a red hue, a G signal corresponding to a green hue, and a B signal corresponding to a blue hue, and outputting hue signals, saturation signals, and first luminance signals for the plurality of pixels of the image based on the corresponding input image signals;
calculating margin values indicating margins with respect to maximum brightnesses, for the corresponding hue signals;
setting up control values for controlling the first luminance signals based on the corresponding saturation signals and the corresponding margin values;
adjusting brightnesses of the first luminance signals based on the first luminance signals and the corresponding control values and outputting second luminance signals with the adjusted brightnesses; and
converting a color space based on the hue signals, the saturation signals, and the second luminance signals and outputting output image signals, each of which includes an R signal, a G signal, and a B signal according to the converted color space.

14. An image display device comprising:
an image signal adjusting unit which adjusts gradation of each of a plurality of pixels in respectively corresponding input image signals; and
an image display unit which displays an image based on the image signals adjusted by the image signal adjusting unit,
wherein the image signal adjusting unit comprises:
a first color space converting unit which converts a color space based on the input image signals and which outputs hue signals, saturation signals, and first luminance signals for the plurality of pixels based on the input image signals;
a margin value calculating unit which calculates margin values indicating margins with respect to maximum brightnesses for the corresponding hue signals;
a control value set up unit which sets up control values for controlling the corresponding first luminance signals based on the corresponding saturation signals and the corresponding margin values;
a brightness adjusting unit which adjusts brightnesses of the first luminance signals based on the first luminance signals and the corresponding control values, and which outputs second luminance signals with the adjusted brightnesses; and
a second color space converting unit which converts a color space based on the hue signals, the saturation signals, and the second luminance signals and which outputs output image signals having the converted color space to the image display unit.

15. The image display device of claim 14, wherein each of the input image signals and the output image signals comprises an R signal corresponding to a red hue, a G signal corresponding to a green hue, and a B signal corresponding to a blue hue.

16. The image display device of claim 14, wherein the image display unit comprises:
a display unit which displays the image indicated by the output image signals;
a row driving unit and a column driving unit which apply voltages signals to the plurality of pixels in the display unit, such that each of the pixels emits light; and
a display control unit which inputs control signals to the row driving unit or the column driving unit to apply voltages for turning the pixels on or off according to the output image signals adjusted by the image signal adjusting unit.

17. The image display device of claim 14, wherein the control value set up unit sets up the control values based on the corresponding margin values, the corresponding saturation signals, and corresponding maximum defining information.

18. The image display device of claim 14, wherein the brightness adjusting unit adjusts the brightnesses of the first luminance signals by multiplying the corresponding control values by the first luminance signal.

19. A method of processing an image, the method comprising:
converting a color space based on input image signals respectively corresponding to a plurality of pixels of the image and outputting hue signals, saturation signals, and first luminance signals based on the input image signals;
adjusting brightnesses of the first luminance signals based on the corresponding saturation signals and corresponding margin values indicating margins with respect to maximum brightnesses for the corresponding hue signals, and outputting second luminance signals with the adjusted brightnesses; and
converting a color space based on the hue signals, the saturation signals, and the second luminance signals and outputting output image signals having the converted color space.

20. A computer readable recording medium having recorded thereon a program executable by a computer for performing the method of claim 19.
